(19) United States
(12) Patent Application Publication
(10) Pub. No.: US 2012/0005352 A1
(43) Pub. Date: Jan. 5, 2012

(54) INFORMATION PROCESSING APPARATUS, PROGRAM, AND METHOD

(75) Inventor: Minoru NITTA, Kawasaki (JP)

(73) Assignee: FUJITSU LIMITED, Kawasaki-shi (JP)

(21) Appl. No.: 13/165,362

(22) Filed: Jun. 21, 2011

(30) Foreign Application Priority Data
Jun. 30, 2010 (JP) 2010-150426

(51) Int. Cl. G06F 15/16

(52) U.S. Cl. 709/227

(57) ABSTRACT

An information processing method for transmitting a provisional response signal, the information processing method includes: receiving a request signal indicating a request for processing; determining whether a load to be processed in a local device exceeds or equals to a threshold value; transmitting a provisional response signal that stops re-transmission of the request signal to a transmission source of the request signal when it is determined that the load to be processed exceeds or equals to the threshold value in the determining operation and the request signal is received; and transmiting the provisional response signal to the transmission source of the request signal when it is determined that the load to be processed falls below the threshold value in the determining operation and a specific time period elapses after the request signal is received.

### CROSS-REFERENCE TO RELATED APPLICATIONS

This application is based upon and claims the benefit of priority of the prior Japanese Patent Application No. 2010-150426, filed on Jun. 30, 2010, the entire contents of which are incorporated herein by reference.

### FIELD

Embodiments discussed herein relate to an information processing apparatus, an information processing program, and an information processing method.

### BACKGROUND

Conventionally, a Session Initiation Protocol (SIP) server has been used which connects terminals on an internet protocol (IP) network using SIP. The SIP server controls the connection among the terminals based on transmission and reception of SIP signals called a request and a response, respectively. The response includes a provisional response indicating an operation state and a final response indicating the completion of an operation.

For example, a case is described in which the SIP server controls the connection between a terminal A and a terminal B in response to a request from the terminal A. When the SIP server receives an INVITE signal that requests the connection of the terminal A and the terminal B from the terminal A, the SIP server transfers the received INVITE signal to the terminal B. The terminal B that has received the INVITE signal creates a response to report the success of the request from the terminal A and transmits the created response to the SIP server. After that, the SIP server receives the response from the terminal B and transfers the received response to the terminal A. The terminal A that has received the response transmits an ACK signal that is a request to confirm the connection, to the SIP server. The SIP server may establish the connection between the terminal A and the terminal B when the SIP server transmits the ACK signal received from the terminal A, to the terminal B.

The SIP server may perform high-speed processing to the transmission and reception of the request and response using a User Datagram Protocol (UDP) that is not desirably reliabilile for the transmission and reception. Thus, when the terminal A that has transmitted an INVITE signal does not receive a final response from the SIP server, it is difficult for the terminal A to determine whether the request does not arrive at the SIP server, or the SIP server is in a processing operation. Thus, when the terminal A does not receive a response from the SIP server after a certain time period elapses, the terminal A determines that the request has not arrived at the SIP server and re-transmits the INVITE signal.

When the SIP server receives an INVITE signal from the terminal A and further receives the INVITE signal re-transmitted from terminal A, processing to be performed in the SIP server increases undesirably. Thus, when the SIP server receives an INVITE signal from terminal A and does not transmit a response to the terminal A within a certain time period, the SIP server transmits a provisional response. A provisional response is not a signal indicating a final response but a response to provisionally notify the terminal A that the SIP server receives an INVITE signal. In addition, the terminal A that has received a provisional response from the SIP server waits for a final response from the SIP server without re-transmission of an INVITE signal even when the terminal A does not receive the final response from the SIP server after a certain time period elapses.

The SIP server transmits a provisional response instantaneously after the SIP server receives an INVITE signal. For example, as illustrated in FIG. 11A, the SIP server transmits a provisional response 100 Trying (A) without waiting for the transmission of a final response 200 OK (A) instantaneously after the SIP server receives an INVITE signal. FIG. 11A illustrates an example of a case in which the SIP server instantaneously transmits a provisional response signal in the related art.

In addition, as illustrated in FIG. 11B, when the SIP server receives an INVITE signal and does not transmit a final response 200 OK (A) even after 200 ms elapse, the SIP server transmits a provisional response 100 Trying (A) in the related art. FIG. 11B illustrates an example of a case in which the SIP server transmits a provisional response signal after waiting for 200 ms in the related art.

In the above-described related art, it is probable that processing performance in a server is reduced undesirably due to transmission of a provisional response.

For example, when the SIP server transmits a provisional response instantaneously after the SIP server receives an INVITE signal, a load C1 of the SIP server may be expressed by “C1=X+Y”. The “X” may be a load generated by the reception of the INVITE signal, and the “Y” may be a load generated by the transmission of the provisional response. Factoring in such loads, correlation between the processing performance in the SIP server and the number of requests per unit time is illustrated in “(1)” of FIG. 12.

In the “(1)” of FIG. 12, in a state where there is a small number of requests per unit time, the processing performance in the SIP server may be reduced. For example, in the state where there is a small number of requests per unit time, when the SIP server transmits a final response within 200 ms, the SIP server generally does not transmit a provisional response because re-transmission of an INVITE signal from a terminal may be prevented. It is probable that instantaneous transmission of a provisional response by the SIP server may cause to generate an undesirable provisional response. Thus, in the state where there is a small number of requests per unit time, when the SIP server transmits a provisional response instantaneously, the processing performance in the SIP server may be reduced. FIG. 12 illustrates correlation between the number of requests per unit time and the server performance at provisional response transmission timing in the related art.

In addition, when the SIP server receives an INVITE signal and does not transmit a final response even after 200 ms elapse, the SIP server transmits a provisional response. In this case, a load C2 of the SIP server may be expressed by “C2=X+l×X+k×Y+m×Z”. The “X” may be a load generated by the reception of the INVITE signal, the “Y” may be a load generated by the transmission of the provisional response, and the “Z” may be a load generated by the processing of waiting for 200 ms. In addition, the “l” may be probability of the SIP server receiving re-transmission of the INVITE signal, the “k” may be probability of the SIP server transmitting the provisional response, and the “m” may be a variation coefficient corresponding to the load generated by the processing of waiting for 200 ms. The “k”, “l”, and “m” increase depending on the loads of the SIP server. Factoring in such loads, correlation between the processing performance in the SIP server and the number of requests per unit time is illustrated in “(2)” of FIG. 12.

In the “(2)” of FIG. 12, in a state where there is a large number of requests per unit time, the processing performance in the SIP server may be reduced. For example, in the state where there are a large number of requests per unit time, start of counting of 200 ms may delay in the SIP server after an INVITE signal is received. That is, a timing at which the SIP server transmits a provisional response may delay. As a result, it is difficult for the SIP server to prevent re-transmission of the INVITE signal from the terminal, thereby increasing the number of received requests. Thus, in the state where there are a large number of requests per unit time, the processing performance in the SIP server may be reduced.

### SUMMARY

According to an aspect of the embodiment, an information processing apparatus includes: a reception unit to receive a request signal indicating a request for processing; a load determination unit to determine whether a load to be processed in a local device exceeds or equals to a threshold value; a first transmission unit to transmit a provisional response signal that stops re-transmission of the request signal, to a transmission source of the request signal when the load determination unit determines that the load to be processed exceeds or equals to the threshold value and the request signal is received; and a second transmission unit to transmit the provisional response signal to the transmission source of the request signal when the load determination unit determines that the load to be processed falls below the threshold value and a specific time period elapses after the request signal is received.

Advantages of the invention will be realized and attained by at least the feature, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates network configuration including a SIP server according to a first embodiment;

FIG. 2 illustrates configuration of a SIP server according to a second embodiment;

FIG. 3 illustrates an example of a SIP signal received in a signal reception unit;

FIG. 4 illustrates an example of an analysis result object stored in a header information storage unit;

FIG. 5A illustrates an example of information stored in a re-transmission proportion storage unit;

FIG. 5B illustrates an example of information stored in a signal count storage unit;

FIG. 5C illustrates an example of information stored in a re-transmission proportion threshold value storage unit;

FIG. 5D illustrates an example of information stored in a signal count threshold value storage unit;

FIG. 6 illustrates an example of information stored in a transaction information storage unit;

FIG. 7 illustrates an example of information stored in a dialogue information storage unit;

FIG. 8 illustrates a flowchart of provisional response transmission processing in the SIP server according to the second embodiment;

FIG. 9 illustrates correlation between the number of requests per unit time and server performance in the SIP server according to the second embodiment;

FIG. 10 illustrates a computer system to execute a provisional response transmission program;

FIG. 11A illustrates an example of a case in which the SIP server instantaneously transmits a provisional response signal in the related art;

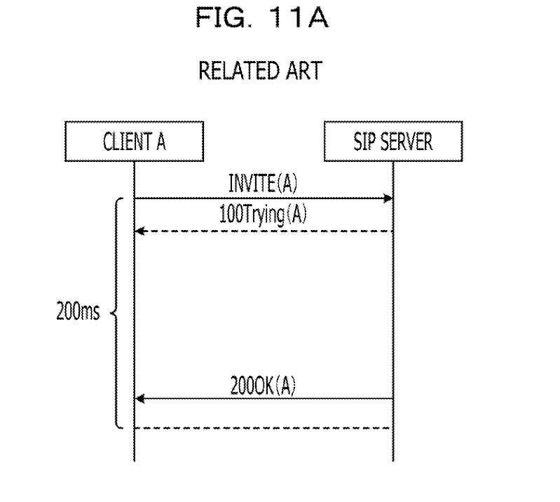

FIG. 11B illustrates an example of a case in which the SIP server transmits a provisional response signal after waiting for 200 ms in the related art; and

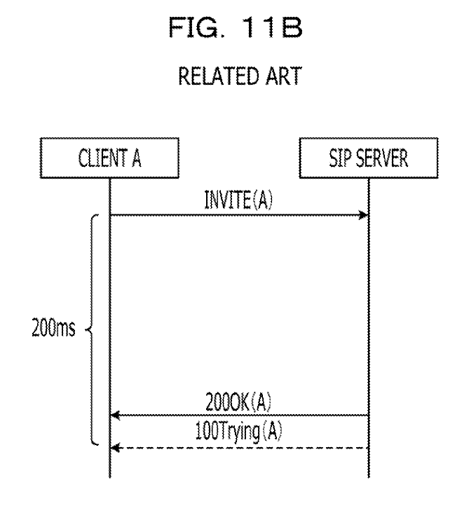

FIG. 12 illustrates correlation between the number of requests per unit time and server performance at provisional response transmission timing in the related art.

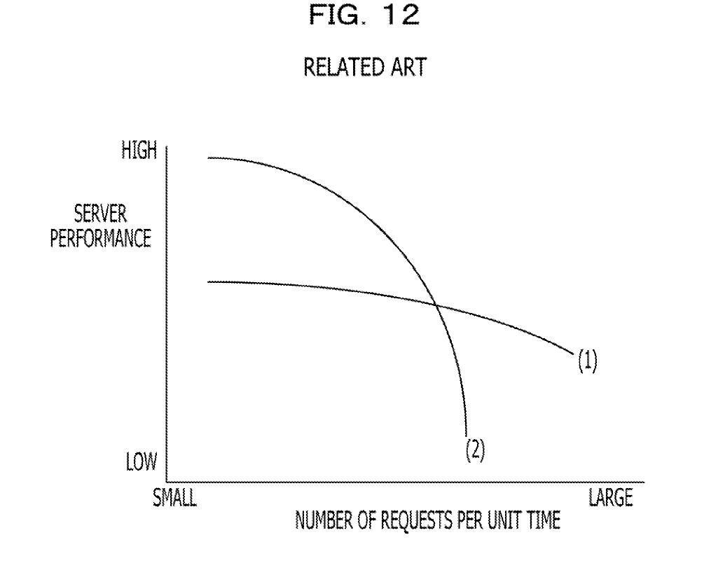

### DESCRIPTION OF EMBODIMENTS

An information processing apparatus, an information processing program, and an information processing method according to embodiments are described below in detail with reference to drawings. The information processing apparatus, the information processing program, and the information processing method discussed herein are not limited to the embodiments.

### First Embodiment

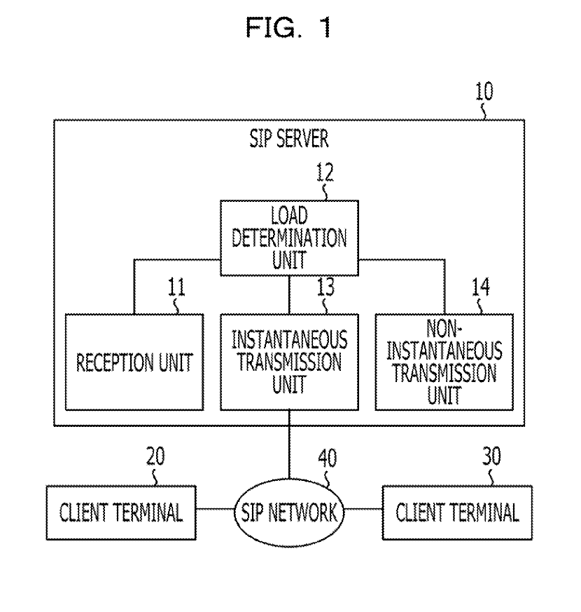

FIG. 1 illustrates a network configuration including a SIP server 10 according to a first embodiment. As illustrated in FIG. 1, the SIP server 10 according to the first embodiment couples a client terminal 20 to a client terminal 30 through a SIP network 40.

The SIP server 10 includes a reception unit 11, a load determination unit 12, an instantaneous transmission unit 13, and a non-instantaneous transmission unit 14. The reception unit 11 receives a request signal indicating a request for processing. The load determination unit 12 determines whether or not a load to be processed in a local device exceeds or equal to a threshold value. When the load determination unit 12 determines the load to be processed in the local device exceeds or equal to the threshold value, the instantaneous transmission unit 13 transmits a provisional response signal to stop re-transmission of the request signal, to transmission source of the request signal instantaneously after the request signal is received. When the load determination unit 12 determines the load to be processed in the local device falls below the threshold value and a certain time period elapses after the request signal has been received, the non-instantaneous transmission unit 14 transmits a provisional response signal to the transmission source of the request signal.

As a result, the SIP server 10 according to the first embodiment may transmit a provisional response signal instantaneously after a request signal is received or determine whether or not to transmit a provisional response signal after a certain time period elapses.

### Configuration of a SIP Server According to a Second Embodiment

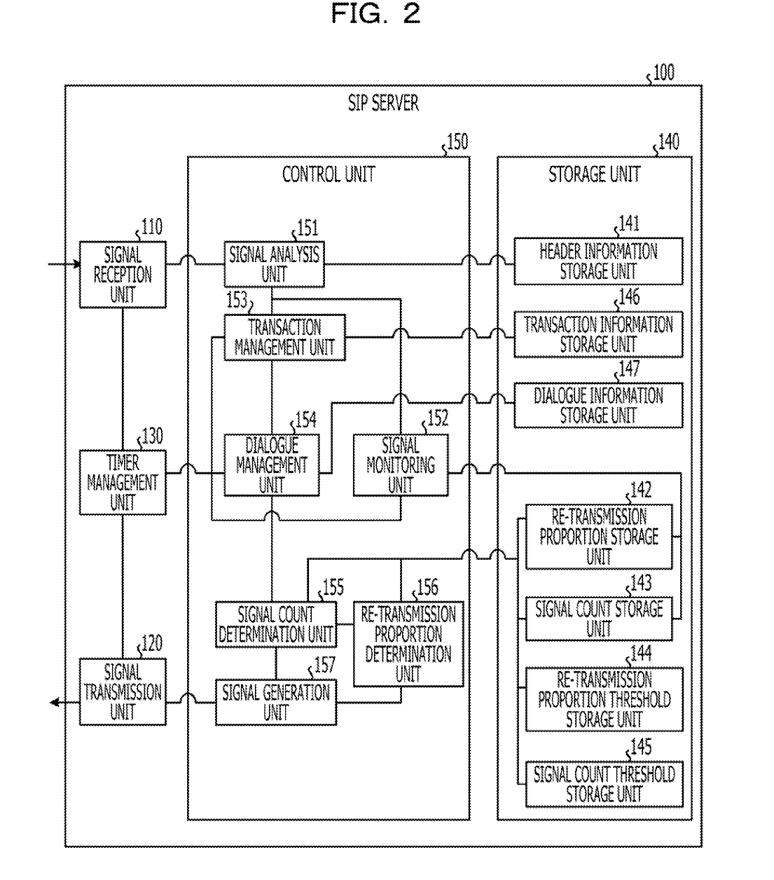

Configuration of a SIP server 100 according to a second embodiment is described below with reference to FIG. 2. FIG. 2 illustrates the configuration of the SIP server 100 according to the second embodiment. As illustrated in FIG. 2, the SIP server 100 according to the second embodiment includes a signal reception unit 110, a signal transmission unit 120, a timer management unit 130, a storage unit 140, and a control unit 150.

The signal reception unit 110 corresponds to a control unit receives a SIP signal from a client terminal and transfers the received SIP signal to a signal analysis unit 151. In addition, the signal reception unit 110 records information including the time at which the SIP signal is received.

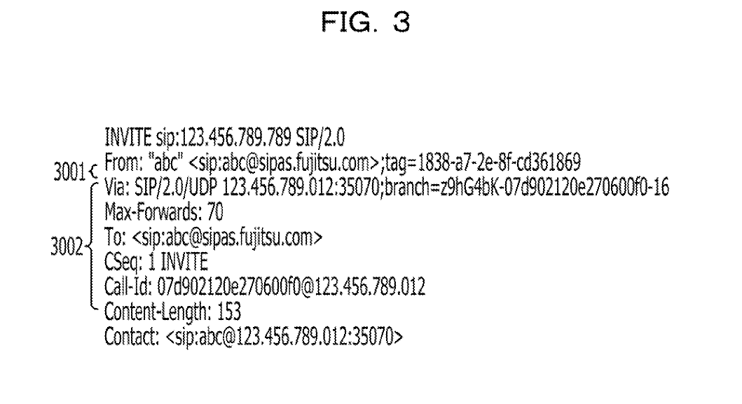

An example of a signal received in the signal reception unit 110 is described below. FIG. 3 illustrates an example of a SIP signal received in the signal reception unit 110. As illustrated in FIG. 3, the SIP signal received in the signal reception unit 110 includes a request line 3001 and a header 3002.

The request line 3001 indicates the type of a received signal. For example, the received signal illustrated in FIG. 3 includes “INVITE” that is a signal to ask the SIP server 100 to couple the client terminal to a recipient. In addition, the header 3002 includes a header name and a header value and specifies a function desired for executing a signal request. For example, the received signal illustrated in FIG. 3 includes “From”, “Via”, “Max-Forwards”, “To”, “CSeq”, “Call-Id”, “Content-Length”, and “Contact” as header names.

The header name “From” indicates logical information of a transmission source of a request. In addition, the header name “Via” indicates information including an address in which a transmission source of a request desire to receive a response, and the response may be transmitted back to the transmission source of the request with reference to the information. In addition, the header name “Max-Forwards” indicates information including limit of the number of hops. In addition, the header name “To” indicates a logical destination of a request. In addition, the header name “CSeq” indicates information including an increment value to distinguish a new transaction from a re-transmission. In addition, the header name “Call-Id” indicates information including a specific ID to identify “calls”. In addition, the header name “Content-Length” indicates information including the body length of the header. In addition, the header name “Contact” indicates where to transit a subsequent request.

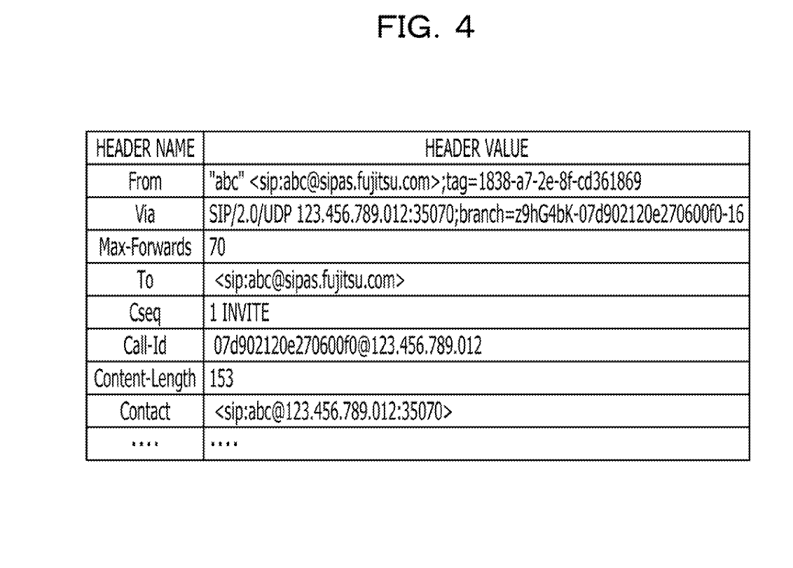

For example, as illustrated in FIG. 4, each of the header names and each of the corresponding header values are associated and stored. For example, a header value corresponding to a header name “From” is “abc <sip:abc©sipas.fujitsu.com>; tag=1838-a7-2e-8f-cd361869”. In addition, a header value corresponding to a header name “Via” is “SIP/2.0/UDP 123.456.789.012:35070; branch=z9hG4bK-07d902120e270600f0-16”. In addition, a header value corresponding to a header name “Max-Forwards” is “70”. In addition, a header value corresponding to a header name “To” is “<sip:abc©sipas.fujitsu.com>”. In addition, a header value corresponding to a header name “CSeq” is “1 INVITE”. In addition, a header value corresponding to a header name “Call-Id” is “07d902120e270600f0©123.456.789.012”. In addition, a header value corresponding to a header name “Content-Length” is “153”. In addition, a header value corresponding to a header name “Contact” is “<sip:abc©123.456.789.012:35070>”. FIG. 4 illustrates an example of an analysis result object stored in a header information storage unit 141.

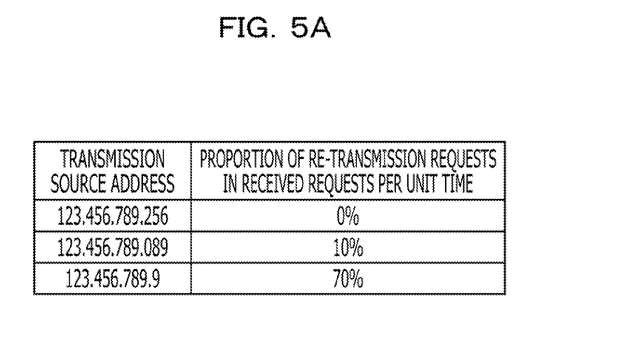

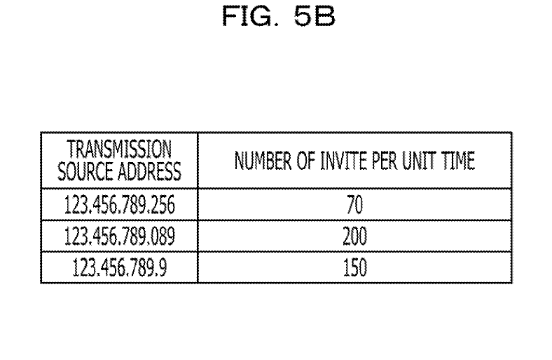

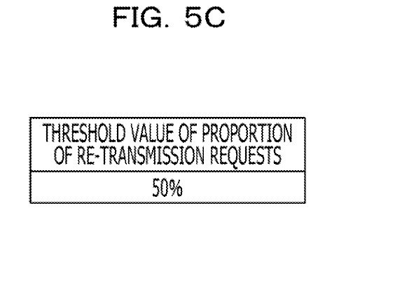

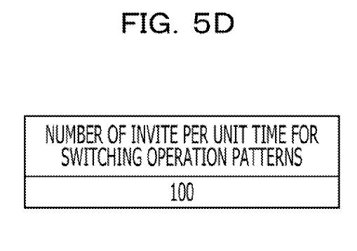

A re-transmission proportion storage unit 142 stores proportion of re-transmission requests in the received requests measured by a signal monitoring unit 152 per unit time with respect to a transmission source terminal. For example, as illustrated in FIG. 5A, the re-transmission proportion storage unit 142 includes items such as “transmission source address” and “proportion of re-transmission requests in received requests per unit time”. Addresses that identify transmission source terminals are stored in the “transmission source address”. In addition, proportion of re-transmission requests included in received requests per unit time is stored in the “proportion of re-transmission requests in received requests per unit time”. FIG. 5A illustrates an example of information stored in the re-transmission proportion storage unit 142.

For example, in the re-transmission proportion storage unit 142 illustrated in FIG. 5A, proportion of re-transmission requests in received requests per unit time from a transmission source terminal having a transmission source address “123.456.789.256” is 0%. In addition, in the re-transmission proportion storage unit 142, proportion of re-transmission requests in received requests per unit time from a transmission source terminal having transmission source address “123.456.789.089” is 10%. In addition, in the re-transmission proportion storage unit 142, proportion of re-transmission requests in received requests per unit time from a transmission source terminal having a transmission source address “123.456.789.9” is 70%.

A signal count storage unit 143 stores the number of INVITE per unit time measured by the signal monitoring unit 152. For example, as illustrated in FIG. 5B, the signal count storage unit 143 includes items such as “transmission source address” and “the number of INVITE per unit time”. Addresses that identify transmission source terminals are stored in the “transmission source address”. In addition, the number of INVITE per unit time received from a transmission source terminal is stored in the “the number of INVITE per unit time”.

For example, in the signal count storage unit 143 illustrated in FIG. 5B, the number of requests per unit time received from a transmission source terminal having a transmission source address “123.456.789.256” is “200”. In addition, in the signal count storage unit 143, the number of requests per unit time received from a transmission source terminal having a transmission source address “123.456.789.089” is “90”. In addition, in the signal count storage unit 143, the number of requests per unit time received from a transmission source terminal having a transmission source address “123.456.789.9” is “70”. FIG. 5B illustrates an example of information stored in the signal count storage unit 143.

A re-transmission proportion threshold storage unit 144 stores threshold values of the proportion of the re-transmission requests in the received requests. For example, in the re-transmission proportion threshold storage unit 144 illustrated in FIG. 5C, information indicating that “threshold value of proportion of re-transmission requests” is “50%” is stored. FIG. 5C illustrates an example of information stored in the re-transmission proportion threshold storage unit 144.

A signal count threshold storage unit 145 stores the number of INVITE per unit time for switching operations patterns. For example, in the signal count threshold storage unit 145 illustrated in FIG. 5D, information indicating that operation pattern is switched when “the number of INVITE per unit time” is “100” is stored. FIG. 5D illustrates an example of information stored in the signal count threshold storage unit 145.

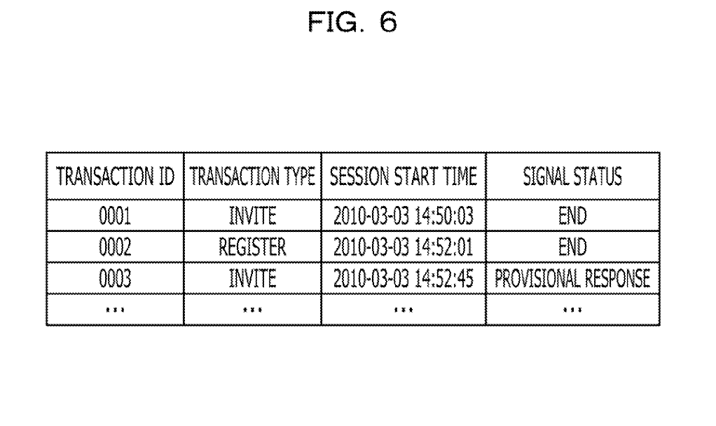

A transaction information storage unit 146 stores state information of SIP transaction processing created by the transaction management unit 153. For example, as illustrated in FIG. 6, the transaction information storage unit 146 associates and stores “transaction ID”, “transaction type”, “session start time”, and “signal status”. FIG. 6 illustrates an example of information stored in the transaction information storage unit 146.

In the “transaction ID”, an identifier that uniquely identifies transactions is stored. In addition, in the “transaction type”, for example, the “INVITE” that is a signal to request establishment of a session and “REGISTER” that is a signal to request registration of an IP addresses are stored as types of received request signals. In addition, in the “session start time”, a time at which a request signal has been received first is stored. In addition, in the “signal status”, for example, information indicating a type of latest transmitted and received signal such as “end” in a case where a session ends, “provisional response”, and “success response” in a case where a session is in progress.

As illustrated in FIG. 6, a transaction having “0001” as the “transaction ID” receives an “INVITE” signal at 14:50:03 on 2010-03-03 and indicates that a session has finished. In addition, a transaction having “0002” as the “transaction ID” receives a “REGISTER” signal at 14:52:01 on 2010-03-03 and indicates that a session has finished. In addition, a transaction having “0003” as the “transaction ID” receives an “INVITE” signal at 14:52:45 on 2010-03-03 and indicates that a provisional response has been transmitted.

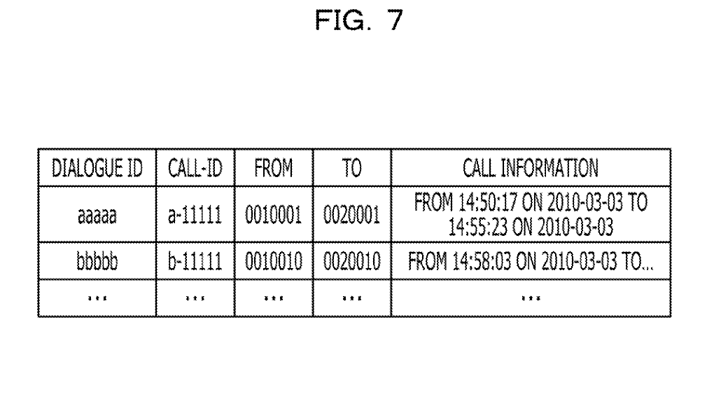

A dialogue information storage unit 147 stores information including dialogues created by the dialogue management unit 154. For example, as illustrated in FIG. 7, the dialogue information storage unit 147 associates and stores “dialogue ID”, “Call-Id”, “From”, “To”, and “call information”. FIG. 7 illustrates an example of information stored in the dialogue information storage unit 147. In addition, generally, the dialogue information storage unit 147 is individually generated for each dialogue.

As illustrated in FIG. 7, an identifier that uniquely identifies dialogues is stored in the “dialogue ID”, and information including a unique ID that identifies “call” is stored in the “Call-Id”. In addition, an access source address of a dialogue is stored in the “From”, and an access distinction addresses of a dialogue is stored in the “To”, and information indicating a call-start time and a call-end time is stored in the “call information”.

For example, a dialogue having “aaaaa” as the “dialogue ID” indicates a connection between “0010001” and “0020001” in which the “Call-Id” is identified as “a-11111”. In addition, the call indicates that the call-start time is at 14:50:17 on 2010-03-03 and the call-end time is at 14:55:23 on 2010-03-03. In addition, a dialogue having “bbbbb” as the “dialogue ID” indicates a connection between “0010010” and “0020010” in which the “Call-Id” is identified as “b-11111”. In addition, the call indicates that the call-start time is at 14:58:03 on 2010-03-03 and the call is currently being performed.

The control unit 150 includes an internal memory to store a control program, a program in which various processing procedures are defined, and desired data. The control unit 150 includes the signal analysis unit 151, the signal monitoring unit 152, the transaction management unit 153, the dialogue management unit 154, a signal count determination unit 155, a re-transmission proportion determination unit 156, and a signal generation unit 157. For example, the control unit 150 may be an integrated circuit such as an Application Specific Integrated Circuit (ASIC) and a Field Programmable Gate Array (FPGA), or an electronic circuit such as a Central Processing Unit (CPU) and a Micro Processing Unit (MPU).

The signal analysis unit 151 analyzes signals received in the signal reception unit 110. For example, when the signal analysis unit 151 receives a SIP signal transferred from the signal reception unit 110, the signal analysis unit 151 extracts a header name and a header value from the header of the SIP signal and generates an analysis result object by associating and storing the extracted header name and header value. The signal analysis unit 151 transfers the analyzed SIP signal to the signal monitoring unit 152 and the transaction management unit 153.

The signal monitoring unit 152 corresponds to a control unit to monitor signals received in the SIP server. For example, when the signal monitoring unit 152 receives an SIP signal from the signal analysis unit 151, the signal monitoring unit 152 extracts a reception time, a transmission source terminal address, and a signal type and stores the reception time, the transmission source terminal address, and the signal type in the storage unit 140. For example, the description is made, as an example, for a case where an INVITE signal is received from a transmission source address 123.456.789.089 at 13:23:45 on 2010-03-17. The signal monitoring unit 152 associates and stores “2010-03-17 13:23:45”, “123.456.789.089”, and “INVITE”. In addition, For example, the description is made, as an example, for a case where re-transmission of an INVITE signal is received from a transmission source address 123.456.789.089 at 13:25:07 on 2010-03-17. The signal monitoring unit 152 associates and records “2010-03-17 13:25:07”, “123.456.789.089”, “INVITE”, and “re-transmission”. The signal monitoring unit 152 compares the currently-received signal with a previously-received signal received, and determines that the currently-received signal is a re-transmission signal when, between the currently-received signal and a previously-received signal received, “branch” that is a header value corresponding to a header name “Via” is the same and then a header value corresponding to a header name “CSeq” is the same. The signal monitoring unit 152 refers to the analysis result objects in the header information storage unit 141 as previously-received signals.

In addition, when the signal monitoring unit 152 accepts a time report from the timer management unit 130 at a certain time intervals, the signal monitoring unit 152 counts the number of received signal and the proportion of re-transmission signals in the received signals with respect to a transmission source terminal. For example, description is made, as an example, for a case where the signal monitoring unit 152 receives an INVITE signal for 90 times per unit time from a transmission source address 123.456.789.089. The signal monitoring unit 152 associates the transmission source address “123.456.789.089” with the number of INVITE per unit time “90” and stores the transmission source address and the number of INVITE in the signal count storage unit 143. In addition, for example, description is made, as an example, for a case where the signal monitoring unit 152 receives re-transmission of an INVITE signal for nine times per unit time from a transmission source address 123.456.789.089. The signal monitoring unit 152 associates the transmission source address “123.456.789.089” with proportion “10%” of re-transmission requests in received requests per unit time and stores the transmission source address and the proportion in the re-transmission proportion storage unit 142.

The transaction management unit 153 corresponds to a control unit to manage the processing state of transactions. For example, the transaction management unit 152 extracts “transaction type”, “session start time”, and “signal status” from a request signal to request processing and a response signal that is a response to the request signal and writes the “transaction type”, the “session start time”, and the “signal status” in the transaction information storage unit 146.

The dialogue management unit 154 corresponds to a control unit to manage connection relationship among terminals coupled to each other, for example, manages information including the call state between a client terminal A and a client terminal B. For example, the dialogue management unit 154 extracts information including “Call-Id”, “From”, and “To” from a header included in a signal received from the transaction management unit 153 and, stores the information in the dialogue information storage unit 147. The dialogue management unit 154 transfers the signal received from the transaction management unit 153 to the signal count determination unit 155.

The signal count determination unit 155 corresponds to a control unit that determines whether or not the number of request signals received per unit time exceeds a certain threshold value when a signal received from the dialogue management unit 154 is an INVITE signal. That is, when the number of request signals received per unit time exceeds a certain threshold value, the signal count determination unit 155 determines that a load to be processed in the SIP server 100 exceeds or equals to a threshold value. That is, the signal count determination unit 155 determines that the load to be processed is high. In addition, when the number of request signals received per unit time does not exceed a certain threshold value, the signal count determination unit 155 determines that the load to be processed in the SIP server 100 falls below a threshold value. That is, the signal count determination unit 155 determines that the load to be processed is low.

For example, the signal count determination unit 155 extracts a request line from a received signal and determines whether or not the received signal is an INVITE signal. When the received signal is an INVITE signal, the signal count determination unit 155 identifies a transmission source terminal. In addition, the signal count determination unit 155 reads the signal count storage unit 143 and the signal count threshold storage unit 145 that correspond to the identified transmission source terminal and determines whether or not the number of INVITE per unit time exceeds a certain threshold value.

Examples are described below with reference to the signal count storage unit illustrated in FIG. 5B and signal count threshold storage unit illustrated in FIG. 5D. The signal count determination unit 155 compares the number of INVITE per unit time “200” corresponding to the transmission source address “123.456.789.256” in FIG. 5B with the threshold value “100” in FIG. 5D, and then determines the number of INVITE exceeds the threshold value. In this case, the signal count determination unit 155 transfers the signal to the signal generation unit 157, and instructs the signal generation unit 157 to instantaneously transmit a provisional response in response to the transferred signal.

In addition, when a value stored in the signal count storage unit 143 falls below a value stored in the signal count threshold storage unit 145, the signal count determination unit 155 transfer the signal to the re-transmission proportion determination unit 156. For example, the signal count determination unit 155 may compare the number of INVITE per unit time “90” corresponding to a transmission source address “123.456.789.089” in FIG. 5B with the threshold value “100” in FIG. 5D, and determine that the number of INVITE does not exceed threshold value. In this case, the signal count determination unit 155 transfers the signal to the re-transmission proportion determination unit 156. Similar to the transmission source address “123.456.789.089”, the signal count determination unit 155 may compare the number of INVITE per unit time corresponding to the transmission source address “123.456.789.9” in FIG. 5B with the threshold value “100” in FIG. 5D and determine that the number of INVITE does not exceed the threshold value “100” in FIG. 5D. In addition, when the signal count determination unit 155 determines a received signal is not an INVITE signal, the signal count determination unit 155 transfers the received signal to the signal generation unit 157.

The re-transmission proportion determination unit 156 corresponds to a control unit that determines whether or not proportion of re-transmission requests in request signals exceeds a certain threshold value when the number of request signals per unit time exceeds a certain threshold value. That is, when proportion of re-transmission requests received per unit time in request signals exceeds a certain threshold value, the re-transmission proportion determination unit 156 determines that a load to be processed exceeds or equals to a certain threshold value. That is, the re-transmission proportion determination unit 156 determines that the load to be processed is high. In addition, when proportion of re-transmission requests received per unit time in request signals falls below the certain threshold value, the re-transmission proportion determination unit 156 determines that a load to be processed falls below the certain threshold value. That is, the re-transmission proportion determination unit 156 determines the load to be processed is low.

For example, the re-transmission proportion determination unit 156 reads the re-transmission proportion storage unit 142 and the re-transmission proportion threshold storage unit 144, and determines whether or not proportion of re-transmission requests in request signals exceeds a certain threshold value. For example, the re-transmission proportion determination unit 156 compares the proportion of re-transmission requests “10%” illustrated in FIG. 5A with a threshold value of proportion of re-transmission requests “50%” illustrated in FIG. 5C with respect to the transmission source address “123.456.789.089”. In this case, the re-transmission proportion determination unit 156 determines that the proportion of the re-transmission requests does not exceed the threshold value. In addition, the re-transmission proportion determination unit 156 transfers the signal to the signal generation unit 157 and instructs the signal generation unit 157 to transmit a provisional response when a final response in response to the transferred signal is not transmitted within 200 ms.

In addition, the re-transmission proportion determination unit 156 compares the proportion of re-transmission requests “70%” illustrated in FIG. 5A with the threshold value of the proportion of re-transmission requests “50%” illustrated in FIG. 5C with respect to the transmission source address “123.456.789.9”. In this case, the re-transmission proportion determination unit 156 determines that the proportion of re-transmission requests in request signals exceeds the threshold value, transmits the signal to the signal generation unit 157, and instructs the signal generation unit 157 to instantaneously transmit a provisional response in response to the transfer signal.

The signal generation unit 157 corresponds to a control unit that generates a response signal in response to a signal received from the signal count determination unit 155 or the re-transmission proportion determination unit 156 and transfers the generated signal to the signal transmission unit 120. For example, the signal generation unit 157 determines whether or not a SIP signal received from the signal count determination unit 155 or the re-transmission proportion determination unit 156 is an INVITE signal.

When the signal generation unit 157 determines a SIP signal received from the signal count determination unit 155 or the re-transmission proportion determination unit 156 is an INVITE signal, the signal generation unit 157 determines whether or not an instruction to instantaneously transmit a provisional response is received. When the signal generation unit 157 determines an instruction to instantaneously transmit a provisional response is received, the signal generation unit 157 generates a provisional response. After that, the signal generation unit 157 transfers the generated provisional response to the signal transmission unit 120 and then instructs the signal transmission unit 120 to instantaneously transmit a provisional response to. In addition, when the signal generation unit 157 is not received an instruction to instantaneously transmit a provisional response, the signal generation unit 157 determines whether or not a final response is transmitted. When the signal generation unit 157 determines a final response is not transmitted within 200 ms, the signal generation unit 157 transfers a provisional response to the signal transmission unit 120 and instructs the signal transmission unit 120 to instantaneously transmit a provisional response.

When the signal generation unit 157 determines a SIP signal received from the signal count determination unit 155 or the re-transmission proportion determination unit 156 is not an INVITE signal, for example, the signal generation unit 157 generates a new signal by updating the header of the signal. The signal generation unit 157 transfers the generated new signal to the signal transmission unit 120.

[Provisional Response Transmission Processing in the SIP Server]

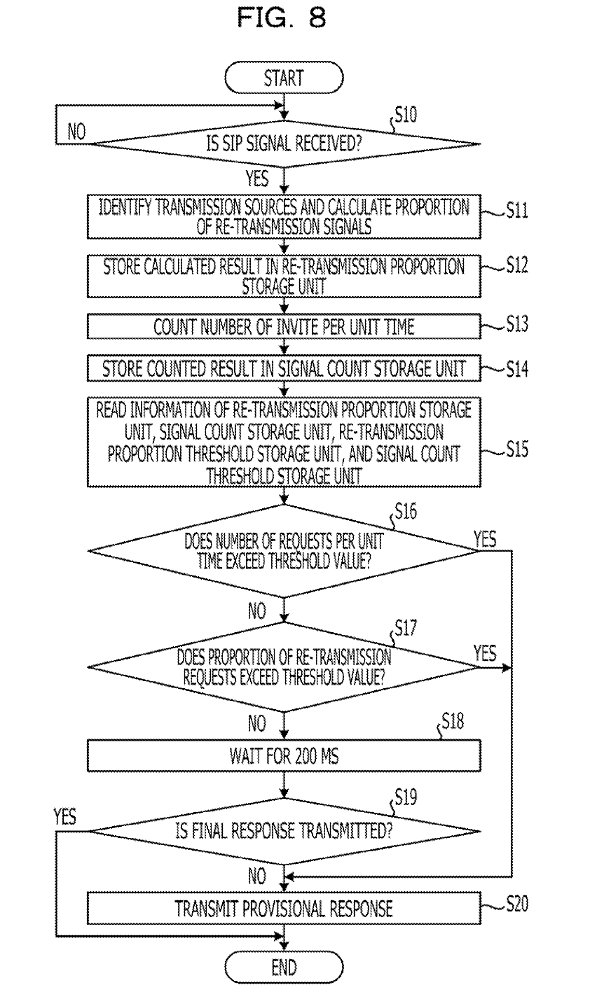

Provisional response transmission processing in the SIP server 100 is described with reference to FIG. 8. FIG. 8 illustrates a flowchart of the provisional response transmission processing in the SIP server 100. As illustrated in FIG. 8, in the SIP server 100, when the signal reception unit 110 receives a SIP signal (YES, in Operation S10), the signal monitoring unit 152 identifies transmission sources and calculates proportion of re-transmission signals in request signals (Operation S11). After that, the signal monitoring unit 152 stores the calculated result in the re-transmission proportion storage unit 142 (Operation S12). After that, the signal monitoring unit 152 counts the number of INVITE signal per unit time (Operation S13) and stores the counted result in the signal count storage unit 143 (Operation S14).

The signal count determination unit 155 reads information of the re-transmission proportion storage unit 142, the signal count storage unit 143, the re-transmission proportion threshold storage unit 144, and the signal count threshold storage unit 145 (Operation S15). In addition, the signal count determination unit 155 determines whether or not the number of requests per unit time exceeds a certain threshold value (Operation S16). When the signal count determination unit 155 determines that the number of requests per unit time exceeds a certain threshold value (YES, in Operation S16), the signal count determination unit 155 transfers the received signal to the signal generation unit 157 and causes the signal generation unit 157 to generates a provisional response. In addition, the signal transmission unit 120 transmits the provisional response generated by the signal generation unit 157 (Operation S20).

In addition, when the signal count determination unit 155 determines that the number of requests per unit time does not exceed a certain threshold value (NO, in Operation S16), the signal count determination unit 155 transfers the signal to the re-transmission proportion determination unit 156. In addition, the re-transmission proportion determination unit 156 determines whether or not proportion of re-transmission requests in request signals exceeds a certain threshold value (Operation S17). When the re-transmission proportion determination unit 156 determines that proportion of re-transmission requests in request signals exceeds a certain threshold value (YES, in Operation S17), the re-transmission proportion determination unit 156 transfers the received signal to the signal generation unit 157 and causes the signal generation unit 157 to generate a provisional response. In addition, the signal transmission unit 120 transmits the provisional response generated by the signal generation unit 157 (Operation S20).

In addition, when the re-transmission proportion determination unit 156 determines proportion of re-transmission requests in request signals does not exceed a certain threshold value (NO, in Operation S17), re-transmission proportion determination unit 156 transfers the received signal to the signal generation unit 157. When the signal generation unit 157 waits for 200 ms (Operation S18), the signal generation unit 157 determines whether or not a final response is transmitted (Operation S19). When the signal generation unit 157 determines that a final response is not transmitted (NO, in Operation S19), the signal generation unit 157 generates a provisional response. In addition, the signal transmission unit 120 transmits the provisional response generated by the signal generation unit 157 (Operation S20). In addition, when the signal generation unit 157 determines that a final response is transmitted (YES, in Operation S19), the processing ends.

In the SIP server 100 according to the second embodiment, the signal monitoring unit 152 monitors the number of SIP signals received in the signal reception unit 110 per unit time. In addition, the signal count determination unit 155 determines whether or not the number of signals per unit time exceeds a threshold value. When the signal count determination unit 155 determines the number of signals per unit time exceeds a signal count threshold value, the signal count determination unit 155 transmits a provisional response instantaneously. In addition, the signal count determination unit 155 determines the number of signals per unit time does not exceed a signal count threshold value, the signal count determination unit 155 waits for 200 ms and transmits a provisional response when a final response is not transmitted. As a result, the SIP server 100 according to the second embodiment may change a transmission timing of the provisional response based on load status in the local device. That is, the SIP server 100 according to the second embodiment may reduce if not substantially prevent undesirable transmission of a provisional response and undesirable re-transmission of a received signal.

In addition, in the SIP server 100 according to the second embodiment, when the number of requests per unit time does not exceed a threshold value, the re-transmission proportion determination unit 156 calculates re-transmission proportion per unit time and determines whether or not the calculated re-transmission proportion exceeds a re-transmission proportion threshold value. When the calculated re-transmission proportion exceeds a re-transmission proportion threshold value, the re-transmission proportion determination unit 156 instantaneously transmits a provisional response. In addition, when the calculated re-transmission proportion does not exceed a re-transmission proportion threshold value, the re-transmission proportion determination unit 156 waits for 200 ms and transmits a provisional response when a final response is not transmitted. As a result, even when the number of signals per unit time does not exceed a signal count threshold value, the SIP server 100 according to the second embodiment determines re-transmission proportion, thereby reducing if not substantially preventing undesirable re-transmission of a provisional response. As a result, the SIP server 100 may reduce an amount of signals on the network.

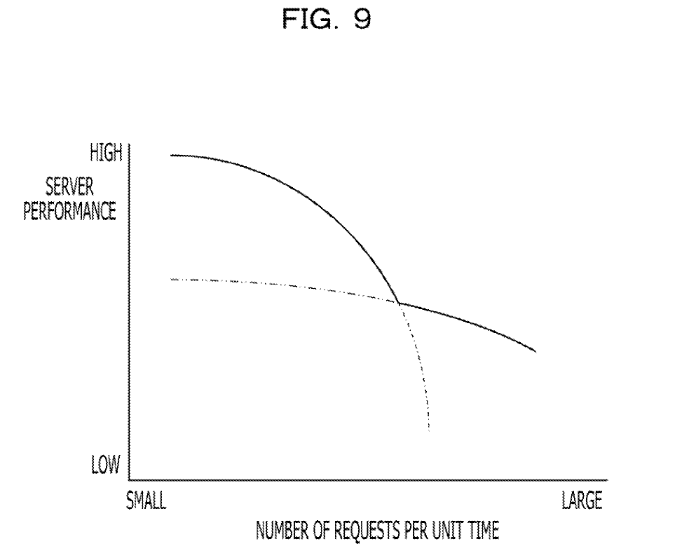

An example correlation between the number of requests per unit time and server performance in the SIP server according to the second embodiment is described with reference to FIG. 9. When there is few signals per unit time, the SIP server 100 waits for 200 ms and transmits a provisional response in a case where a final response is not transmitted, thereby reducing if not substantially preventing undesirable transmission of a provisional response and improving the server performance. In addition, when there are a lot of signals per unit time, the SIP server 100 instantaneously transmits a provisional response, thereby reducing if not substantially preventing undesirable re-transmission of a provisional response from the transmission source terminal and improving the server performance.

In addition, the SIP server 100 according to the second embodiment may set a re-transmission proportion threshold value and a signal count threshold value for each transmission source terminal. For example, when the SIP server 100 set a re-transmission proportion threshold value with respect to a certain transmission source terminal so that the re-transmission proportion threshold value is low, the SIP server 100 may preferentially transmit a provisional response to the certain transmission source terminal. In addition, when the SIP server 100 set a signal count threshold value with respect to a certain transmission source terminal so that the signal count threshold value is low, the SIP server 100 may preferentially transmit a provisional response to the certain transmission source terminal. Thus, the SIP server 100 according to the second embodiment may set a priority level to a certain transmission source terminal and communicate with the certain transmission source terminal.

### A Third Embodiment

The SIP server discussed hereinabove may be achieved by using a variety of modifications other than embodiments discussed hereinabove. Hereinafter, an information processing apparatus according to another embodiment is described.

(System Configuration, etc)

All or part of the processing procedures that are automatically performed from among the processing procedures described in the above-described embodiments may be manually performed. In addition, all or part of the processing procedures that are manually performed from among the processing procedures described in the above-described embodiments may be automatically performed. In addition, the processing procedures, the control procedures, and the specific names that are described in the embodiments above and illustrated in FIGS. may be altered, unless specified in particular.

In addition, information stored in the illustrated storage unit is a mere example, and the information may not be stored as illustrated. In addition, the signal monitoring unit 152 causes the re-transmission proportion storage unit 142 and the signal count storage unit 143 to move to a secondary storage device at a desired time point such as the end of related communication, and the moved information may be in a reusable state. In addition, the re-transmission proportion threshold storage unit 144 and the signal count threshold storage unit 145 may be stored in the secondary storage device. For example, the secondary storage device may be a portable physical medium, which is inserted into the SIP server 100, such as a flexible disk (FD), a compact disc-read-only memory (CD-ROM), a magneto optical (MO) disk, a digital versatile disc (DVD), an optical magnetic disk, and an integrated circuit (IC) card.

In addition, in the embodiments, the information processing apparatus is described as the SIP server, however, the information processing apparatus applicable to the embodiments is not limited to the SIP server. For example, the information processing apparatus applicable to the embodiments may also be applied to a server device using UDP. For example, the information processing apparatus may be a Hyper Text Transfer Protocol (HTTP) server using UDP.

In addition, as described above, the SIP server 100 monitors the number of signals per unit time and determines whether or not a load to be processed is high in the local device, however, the monitoring in the SIP server 100 is not limited to monitoring the number of signals per unit time. For example, the SIP server 100 may be designed or configured so as to monitor a usage of CPU or a memory in addition to the number of signals per unit time and then determine a load.

In addition, the SIP server 100 calculates re-transmission proportion and the number of signals for each transmission source terminal and then determines a load. Alternatively, the SIP server 100 may calculate re-transmission proportion and the number of signals as the whole system and then determine a load. For example, the re-transmission proportion storage unit 142 and the signal count storage unit 143 may calculate the number of re-transmission signals and the number of signals that are received as the SIP server 100 and then determine a load.

In addition, the SIP server 100 determines whether or not a load to be processed is high in the local device based on the number of signals per unit time. When the SIP server 100 determines a load to be processed is low, the SIP server 100 determines whether or not a load to be processed is high in the local device based on re-transmission proportion. Alternatively, the SIP server 100 may determine whether or not a load to be processed is high merely based on the number of signals per unit time. In addition, the SIP server 100 may determine whether or not a load to be processed is high merely based on the re-transmission proportion. That is, the SIP server 100 may determines whether or not a load to be processed is high in the local device by arbitrarily combining the methods for determining whether or not a load to be processed is high according to the second embodiment.

In addition, each of the configuration units illustrated in the FIGS. is based on functional concept, and each of the configuration units is not limited to the configurations illustrated in the FIGS. For example, in the SIP server 100, the signal analysis unit 151 and the signal monitoring unit 152 may be integrated. In addition, all or part of each processing function performed in each of the devices may be realized by CPU and by a program analyzed and performed in the CPU, or all or part of each of the processing functions may be realized as hardware by wired logic.

(Program)

Various processing in the above-described embodiments may be realized by executing a previously prepared program in a computer system such as a personal computer and a workstation. An example of a computer system in which a program including functions similar to the functions of the above-described embodiments is executed is described below.

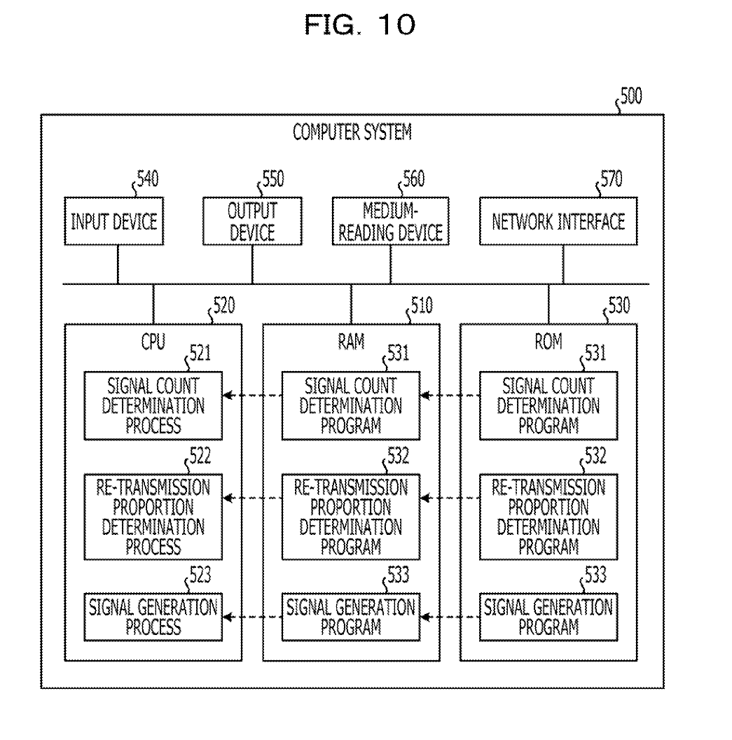

FIG. 10 illustrates a computer system to execute a provisional response transmission program. As illustrated in FIG. 10, a computer system 500 includes a random access memory (RAM) 510, a read-only memory (ROM) 530, a CPU 520, a input device 540, a outputdevice 550, a medium-reading device 560, and a network interface 570. Programs that realize functions similar to the functions of the above-described embodiments are previously stored in the ROM 530. That is, as illustrated in FIG. 10, a signal count determination program 531, a re-transmission proportion determination program 532, and a signal generation program 533 are previously stored in the ROM 530.

In addition, the signal count determination program 531, the re-transmission proportion determination program 532, and the signal generation program 533 are read into the CPU 520 and developed into the RAM 510. In addition, the CPU 520 executes the signal count determination program 531 as a signal count determination process 521. In addition, the CPU 520 executes the re-transmission proportion determination program 532 as a re-transmission proportion determination process 522. In addition, the CPU 520 executes the signal generation program 533 as a signal generation process 523. The signal count determination process 521 corresponds to the signal count determination unit 155 illustrated in FIG. 2. In addition, the re-transmission proportion determination process 522 corresponds to the re-transmission proportion determination unit 156, and the signal generation process 523 corresponds to the signal generation unit 157.

The above-described programs 531 to 533 may not be stored in the ROM 530. For example, the programs 531 to 533 may be stored in a portable physical medium, which is inserted into the computer system 500, such as a FD, a CD-ROM, a MO disk, a DVD, an optical magnetic disk, an IC card. In addition, the programs 531 to 533 may be stored in a fixed physical medium, which is installed inside or outside the computer system 500, for example, a hardware disk drive (HDD). In addition, the programs 531 to 533 may be stored in other computer systems coupled to the computer system 500 through a public network, the Internet, a Local Area Network (LAN), a Wide Area Network (WAN). In addition, the computer system 500 may read the programs 531 to 533 from the above-described physical mediums and the other computer systems and executes the programs 531 to 533.

That is, the above-described programs 531 to 533 may be computer-readably stored in a recording medium such as the above-described portable physical medium, the fixed physical medium, and the communication medium. In addition, the computer system 500 realizes functions similar to the functions in the above-described embodiments by reading the programs from such recording medium and executing the programs. The above-described programs 531 to 533 may not be performed by the computer system 500. For example, the above-described embodiments may also be applied to a case where another computer system or a server executes the programs 531 to 533 or a case where another computer system and a server execute the programs 531 to 533 in cooperation.

Although the embodiments of the present invention are numbered with, for example, “first,” “second,” or “third,” the ordinal numbers do not imply priorities of the embodiment. Many other variations and modifications will be apparent to those skilled in the art.

All examples and conditional language recited herein are intended for pedagogical purposes to aid the reader in understanding the aspects of the invention and the concepts contributed by the inventor to furthering the art, and are to be construed as being without limitation to such specifically recited examples and conditions, nor does the organization of such examples in the specification relate to a showing of the superiority and inferiority of the aspects of the invention. Although the embodiment in accordance with aspects of the present invention has been described in detail, it should be understood that various changes, substitutions, and alterations could be made hereto without departing from the spirit and scope of the invention.

Moreover, the term “or” is intended to indicate an inclusive “or” rather than an exclusive “or”. That is, unless specified otherwise, or clear from the context, the phrase “X employs A or B” is intended to indicate any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to indicate “one or more” unless specified otherwise or clear from the context to be directed to a singular form.

What is claimed is:

1. An information processing apparatus comprising:
a reception unit to receive a request signal indicating a request for processing;
a load determination unit to determine whether a load to be processed in a local device exceeds or equals to a threshold value;
a first transmission unit to control to allow to transmit a provisional response signal that stops re-transmission of the request signal, to a transmission source of the request signal when the load determination unit determines that the load to be processed exceeds or equals to the threshold value and the request signal is received; and
a second transmission unit to transmit the provisional response signal to the transmission source of the request signal when the load determination unit determines that the load to be processed falls below the threshold value and a specific time period elapses after the request signal is received.

2. The information processing apparatus according to claim 1, wherein
the load determination unit determines that the load to be processed exceeds or equals to the threshold value when a number of request signals received in the reception unit per unit time exceeds or equals to a specific value.

3. The information processing apparatus according to claim 1, wherein
the reception unit receives a re-transmission request signal transmitted from a transmission source that does not receive a response signal in response to the request signal, and
the load determination unit determines the load to be processed exceeds or equals to the threshold value when a number of re-transmission request signals received in the reception unit per unit time exceeds or equals to a specific value.

4. The information processing apparatus according to claim 1, wherein the reception unit receives a re-transmission request signal transmitted from a transmission source that does not receive a response signal in response to the request signal, and
the load determination unit determines the load to be processed exceeds or equals to the threshold value when a proportion of re-transmission request signals in signals received in the reception unit per unit time exceeds or equals to a specific value.

5. A computer-readable, non-transitory medium storing an information processing program that causes a computer to execute a procedure, the procedure comprising:
receiving a request signal indicating a request for processing;
determining whether a load to be processed in a local device exceeds or equals to a threshold value;
transmitting a provisional response signal that stops re-transmission of the request signal to a transmission source of the request signal when it is determined that the load to be processed exceeds or equals to the threshold value in the determining operation and the request signal is received; and
transmiting the provisional response signal to the transmission source of the request signal when it is determined that the load to be processed falls below the threshold value in the determining operation and a specific time period elapses after the request signal is received.

6. An information processing method for transmitting a provisional response signal, the information processing method comprising:
receiving a request signal indicating a request for processing;
determining whether a load to be processed in a local device exceeds or equals to a threshold value;
transmitting a provisional response signal that stops re-transmission of the request signal to a transmission source of the request signal when it is determined that the load to be processed exceeds or equals to the threshold value in the determining operation and the request signal is received; and
transmiting the provisional response signal to the transmission source of the request signal when it is determined that the load to be processed falls below the threshold value in the determining operation and a specific time period elapses after the request signal is received.

7. An information processing apparatus comprising:
a processor configured to determine whether a load to be processed in a local device exceeds or equals to a threshold value, and control to allow to transmit a provisional response signal that stops re-transmission of a request signal indicating a request for processing to a transmission source of the request signal before a specific time period elapses after the request signal is received when it is determined that the load to be processed exceeds or equals to the threshold value, and control to transmit the provisional response signal to the transmission source of the request signal when it is determined that the load to be processed falls below the threshold value and a specific time period elapses after the request signal is received.
